(19) United States
(12) Patent Application Publication
(10) Pub. No.: US 2025/0065271 A1
(43) Pub. Date: Feb. 27, 2025

(54) DEVICE AND METHOD FOR THE EXTRUSION MANUFACTURE OF A POROUS SUPPORT WITH A RECTILINEAR CENTRAL CHANNEL AND NON-RECTILINEAR CHANNELS

(71) Applicant: TECHNOLOGIES AVANCEES ET MEMBRANES INDUSTRIELLES, Nyons (FR)

(72) Inventors: Philippe LESCOCHE, Nyons (FR); Jérôme ANQUETIL, Nyons (FR)

(73) Assignee: TECHNOLOGIES AVANCEES ET MEMBRANES INDUSTRIELLES, Nyons (FR)

(21) Appl. No.: 18/725,925

(22) PCT Filed: Dec. 26, 2022
(86) PCT No.: PCT/FR2022/052505

§ 371 Date: Jul. 1, 2024

(30) Foreign Application Priority Data
Dec. 30, 2021 (FR) FR2114677

(51) Int. Cl. B01D 63/06; B01D 69/10; B28B 3/26

(52) U.S. Cl. CPC B01D 63/061; B01D 63/063; B01D 63/066; B01D 69/108; B28B 3/2609; B01D 2315/10

(57) ABSTRACT

The invention relates to a device for the manufacture by extrusion of a porous tubular support from a ceramic composition, the device including:
a fixed extrusion die (6) in which is mounted a punch holder (7) provided with a centered rectilinear punch (8a) and with at least one helically-shaped punch (8) wound around an axis of symmetry (X) along a winding direction and a winding pitch;
a system (10) for driving in rotation the punch holder (7) around said axis of symmetry (X) along a direction of rotation opposite to the direction of winding of the punch(es) (8) and at a speed of rotation synchronized with the linear speed of extrusion of the ceramic composition.

### TECHNICAL FIELD

The present invention relates to the technical field of tangential separation implementing tubular filtration membranes adapted to ensure the separation of the molecules or the particles contained in a fluid medium to be treated, each tubular filtration membrane including a tubular rigid porous support in which one or several non-rectilinear circulation channel(s) for the fluid to be filtered are arranged.

The object of the invention targets more specifically the technical field of the extrusion of the tubular rigid porous supports of the tubular filtration membranes.

The object of the invention finds a particularly advantageous application in the field of filtration in the broad sense, and in particular the nanofiltration, the ultrafiltration, the microfiltration, or the reverse osmosis.

### PRIOR ART

In the state of the art, it is known to use the extrusion in order to shape a porous support of a tubular nature and in which a series of channels is arranged. The extrusion technique has a production rate much higher than the other manufacturing techniques such as the additive manufacturing methods such as the one described for example in documents US 2019/321890 and WO 2020/109715. The linear speed of extrusion, which is measured on minute timescale, is indeed generally equal to or greater than one meter per minute while the vertical printing speed of the additive methods is generally around ten hours per meter at best. It should be noted that the vertical printing speed of the additive methods is highly dependent on the number of channels. It decreases when the number of channels increases and a multichannel support will thus be printed according to said number of channels, two to ten times slower than a single-channel support while the linear speed of extrusion remains independent of the number of channels.

Conventionally, the porous support manufactured by extrusion, for example in inorganic material, such as ceramic can be associated with one or several separating layers, for example in inorganic material, deposited on the surface of each circulation channel and linked to each other and to the support, by sintering. These layers make it possible to adjust the filtration power of the filtration element.

The porous support of these tubular filtration elements has an elongated shape and a straight cross-section, most often polygonal or circular. Numerous extruded supports, including a plurality of channels parallel to each other and to the longitudinal axis of the porous support, have already been proposed. For example, filtration elements including a series of non-circular channels are described in patent application WO 93/07959 on behalf of CERASIV, patent application EP 0 780 148 on behalf of CORNING, patent application WO 00/29098 on behalf of ORELIS, patents EP 0 778 073 and EP 0 778 074 on behalf of the Applicant and patent applications WO 01/62370 on behalf of the technical ceramics company and FR 2 898 513 on behalf of ORELIS.

In operation, the channels communicate, on one side, with an inlet chamber for the fluid medium to be treated and, on the other side, with an outlet chamber. The surface of the channels is, most often, covered with at least one separating layer ensuring the separation of the molecules or the particles contained in the fluid medium circulating inside the channels, along a given direction, from one end of the channels called inlet end to the other end called outlet end. Such a filtration element achieves, by sieve effect, a separation of the molecular or particulate species of the product to be treated, to the extent that all the particles or molecules greater than the diameter of the pores of the area of the filtration element with which they are in contact are stopped. During the separation, the transfer of the fluid takes place through the support and possibly the separating layer(s) when present, and the fluid spreads in the porosity of the support to move towards the external surface of the porous support. The part of the fluid to be treated having passed through the separating layer and the porous support is called permeate or filtrate and is recovered by a collection chamber surrounding the filtration element.

In order to increase the surface of the channels allowing the filtration of the fluid, it is often sought to have a large number of channels within the same support. Due to the large number of channels, the number of possible arrangements of the channels relative to each other is large. Among the claimed advantages of these different forms, the increase of the filter surface without deterioration of the mechanical or intrinsic permeability characteristics of the porous support is in particular mentioned.

It should be noted that in the absence of a channel in the central area of the support containing the axis of symmetry, the volume that would have been occupied by this channel is replaced by porosity. At the start of the operation of such a membrane devoid of a central channel, the surface of the channels closest to this axis of symmetry and facing the latter, produces a permeate that fills said porosity. The discharge of this permeate from this central area to the external surface of the membrane must then be carried out along a path which is maximum for this membrane. This large distance then generates a high-pressure difference between the external surface and said central area around the axis of symmetry, the value of the pressure being maximum around this area. During the operation of the membrane, this maximum value which opposes the pressure in the retentate will increase until it equals it. The flow rate in this area is then zero and an accumulation of liquid which is difficult or even impossible to replace, even by washing, appears under these conditions. This absence of circulation in the porosity of this central area of the support and its resulting inaccessibility to the wash reagents means that, if this accumulated liquid contains bacteria, these can proliferate without the possibility of being eliminated, thus making unlikely the use of a membrane without a central channel in the agri-food industry.

The shape and disposition of the channels depend directly on the extrusion operation. As a reminder, the extrusion is a (thermo) mechanical shaping method by which a ceramic composition is forced by compression to pass through an orifice having the section of the part to be obtained. This orifice corresponds to the space left free between one or several punches and the die delimiting the external shell of said section.

In the prior art, in order to increase the filtrate stream aimed at reducing the clogging phenomenon, it has been proposed to create a turbulent flow regime inside the channel of a tubular filter element. It has thus been proposed to make imprints or reliefs on the inner wall of the channels to create, in the vicinity of the filter surface, a disturbance for the fluid medium, thus limiting the accumulation of material and the clogging.

Patent EP 0 813 445 describes a method for making imprints on the outside of a porous tube including a single channel, said imprints, which are made while the tube is still deformable, generating a homologous deformation of the internal wall of said channel.

Patent FR 2 736 843 teaches how to make porous tubes including a single channel whose wall includes imprints, while the peripheral wall of the support is smooth. For this, the porous tube is shaped, by means of a fixed extrusion die in which is mounted, as illustrated in FIG. 1, a punch holder provided with a punch P driven in rotation by a motor around its axis, along any direction of rotation. The ceramic composition is forced, by a supply device located upstream, to cross under pressure the punch holder in order to pass through the extrusion die at a linear speed of extrusion. The punch P is provided with one or several rectilinear notches E making it possible to obtain by extrusion a porous support with a single channel on the internal wall of which one or several helical ribs are formed in relief.

The methods described in these two documents (EP 0 813 445 and FR 2 736 843) only allow obtaining wall reliefs in a tube moreover including a single channel and they cannot be transposed to the manufacture of porous supports including several inner channels. However, the multichannel filtration elements are increasingly sought because they allow increasing the filter surface and thus increasing their performance.

It should be noted that an extrusion method for the manufacture of the cooling channels using helical punches is known from document WO 93/20961 in the field of drilling tools provided with cooling channels.

### DISCLOSURE OF THE INVENTION

The present invention therefore aims to overcome the drawbacks of the prior art by proposing to provide new extruded filtration supports which have a multichannel structure with a geometry adapted to increase the stream of the filtrate, with a production rate much higher than that of the additive methods.

One object of the invention is to propose a porous tubular support that can be used in all areas of application.

One object of the invention is to propose a porous tubular support for a tangential filtration membrane, in the form of a sintered monolithic ceramic porous body, manufactured by extrusion of a ceramic composition including a powdery solid inorganic phase and in which are arranged by extrusion using punches, a rectilinear channel centered on an axis of symmetry of the support and at least one circulation channel for a fluid medium to be treated with a helical shape wound around the axis of symmetry, the channels having a limited wall roughness and lower than the granularity of the powdery solid inorganic phase of the ceramic composition.

Advantageously, the sintered monolithic ceramic porous body supports an inner pressure of at least 10 bars without bursting.

Another object of the invention is to provide a tangential filtration membrane according to which at least one separating layer coats the wall of the circulation channels for the fluid medium to be treated of the porous tubular support in accordance with the invention.

Another object of the invention is therefore to propose a new device adapted to ensure the manufacture by extrusion of a porous tubular support having a multichannel structure with a geometry adapted to increase the stream of the filtrate.

The object of the invention is to propose a device in accordance with the invention for the manufacture by extrusion of a porous tubular support from a ceramic composition, including:
a fixed extrusion die in which a punch holder provided with at least one punch is mounted;
a system for driving in rotation the punch holder;
and a supply device to force the ceramic composition to cross under pressure the punch holder in order to pass through the extrusion die at a linear speed of extrusion. According to the invention, the device includes:
a punch holder provided with a rectilinear punch centered on the axis of symmetry and with at least one helically-shaped punch wound around an axis of symmetry along a winding direction and a winding pitch;
a drive system driving in rotation the punch holder around said axis of symmetry along a direction of rotation opposite to the direction of winding of the punch(es) and at a speed of rotation equal to the linear speed of extrusion of the ceramic composition, divided by the winding pitch of the helically-shaped punches.

According to one advantageous variant of embodiment, the punch holder is provided with several punches concentrically wound around a common axis of symmetry in the same winding direction and the same winding pitch.

According to another advantageous variant of embodiment, the punch holder is provided with several punches disposed in at least two concentric rings.

Advantageously, each helically-shaped punch has a length taken along the axis of symmetry, equal to or greater than a quarter of the winding pitch.

According to another characteristic of the invention, the drive system drives in rotation the punch holder with a speed of rotation equal to the linear speed of extrusion of the ceramic composition, divided by the winding pitch of the punches, by taking into account a tolerance margin of plus or minus 15%.

For example, the supply system is a piston or worm-type system.

Advantageously, the device includes a system for heating the extrusion die to maintain the punch holder, the punch(es) and the ceramic composition at a temperature comprised between 50° C. and 300° C.

According to one exemplary embodiment, the system for driving in rotation the punch holder is mounted downstream of the supply system.

According to another exemplary embodiment, the system for driving in rotation the punch holder is located on the side of the punch holder so that the axis of symmetry of the punch holder is parallel to the supply direction of the supply system.

According to another exemplary embodiment, the system for driving in rotation the punch holder is located at the rear of the punch holder so that the axis of symmetry of the punch holder makes an angle less than or equal to 90° relative to the supply direction of the supply system opening out upstream or downstream of the punch holder.

Another object of the invention is to propose a method for manufacturing a porous tubular support from a ceramic composition, consisting in:
providing a fixed extrusion die in which is mounted a punch holder provided with a rectilinear punch centered on an axis of symmetry and with at least one helically-shaped punch wound around an axis of symmetry along a winding direction and a winding pitch;
ensuring that the ceramic composition crosses the punch holder in order to pass through the extrusion die at a linear speed of extrusion;
and ensuring that the punch holder is driven in rotation along a direction of rotation opposite to the direction of winding of the helically-shaped punch(es) and with a speed of rotation equal to the linear speed of extrusion of the ceramic composition, divided by the winding pitch of the helically-shaped punch(es).

According to one advantageous characteristic of this method, for the speed of rotation of the punch holder to be equal to the linear speed of extrusion of the ceramic composition, divided by the winding pitch, we act on the adjustment either of only the speed of rotation of the punch holder or only the linear speed of extrusion or the speed of rotation of the punch holder and the linear speed of extrusion.

Advantageously, the fixed extrusion die is supplied with a ceramic

composition including a powdery solid inorganic phase in the form of particles with an average diameter comprised between 0.1 and 150 micrometers and a matrix.

According to another advantageous characteristic, the fixed extrusion die is supplied with a ceramic composition including a first powdery solid inorganic phase in the form of particles with an average diameter comprised between 0.1 and 150 micrometers and a second phase in the form of a matrix comprising at least one hot-melt polymer.

According to another characteristic of this method, at least one extrudate is recovered at the outlet of the fixed extrusion die with a determined length to form a porous tubular support and this extrudate is subjected to a sintering post-treatment.

### BRIEF DESCRIPTION OF THE DRAWINGS

FIG. 1 is a perspective view illustrating a punch holder and a punch of the prior art in the form of a pin provided at its periphery with a rectilinear notch.

FIG. 2 is a perspective view of one exemplary embodiment of a punch holder in accordance with the invention provided with a centered rectilinear punch and with a helically-shaped punch.

FIG. 3 is a perspective view of another exemplary embodiment of a punch holder in accordance with the invention provided with a centered rectilinear punch and with two punches having the same helical shape.

FIG. 4 is a cross-sectional view of the three punches in accordance with the invention, illustrated in FIG. 3.

FIG. 5 is a perspective view of another exemplary embodiment of a punch holder in accordance with the invention provided with three punches having the same helical shape and with a centered rectilinear punch.

FIG. 6 is a cross-sectional view of the four punches in accordance with the invention illustrated in FIG. 5.

FIG. 7 is a perspective view of another exemplary embodiment of a punch holder in accordance with the invention provided with a centered rectilinear punch, with three helically-shaped punches distributed in a first ring concentric with a second ring including eight helically-shaped punches, the three punches of the first ring having a shape different from that of the eight punches of the second ring, the eleven helical punches being wound around an axis of symmetry along the same winding direction and at the same winding pitch.

FIG. 8 is a cross-sectional view of the twelve punches in accordance with the invention illustrated in FIG. 7.

FIG. 9 is a schematic elevation sectional view of a first exemplary embodiment of an extrusion manufacturing device in accordance with the invention.

FIG. 10 is a schematic elevation sectional view of a second exemplary embodiment of an extrusion manufacturing device in accordance with the invention.

FIG. 11A is a schematic elevation sectional view of a third exemplary embodiment of an extrusion manufacturing device in accordance with the invention.

FIG. 11B is a schematic perspective view of a punch holder

implemented in the exemplary embodiment of the manufacturing device illustrated in FIG. 11A.

FIG. 12 is a perspective view of one example of a porous support obtained using an extrusion manufacturing device in accordance with the invention implementing a punch holder illustrated in FIG. 5.

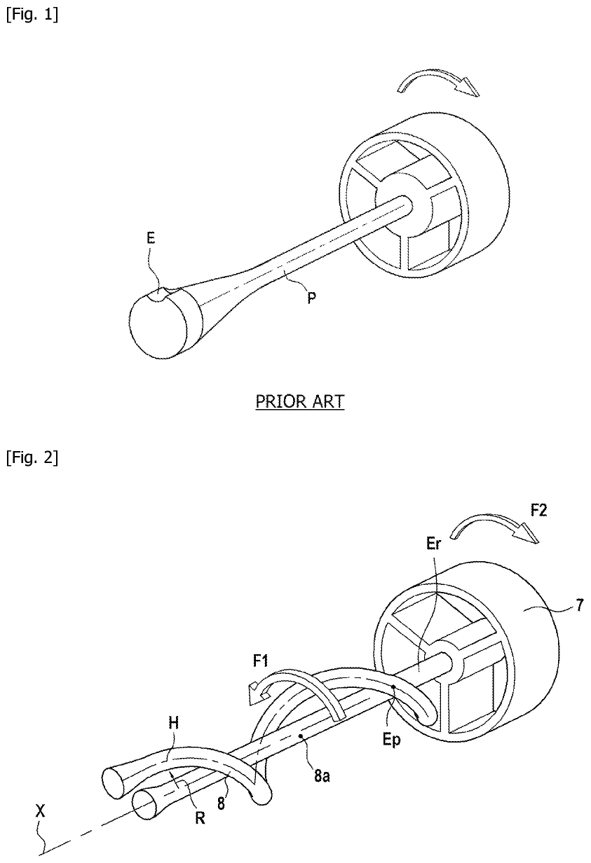

### DESCRIPTION OF THE EMBODIMENTS

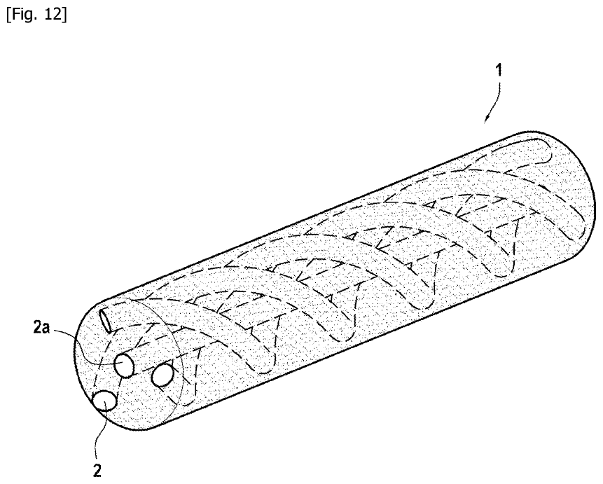

The invention relates to the manufacture by extrusion of a porous support 1, as well as a filtration membrane including the porous support 1 according to the invention comprising a rectilinear channel 2a centered on an axis of symmetry of the porous support and at least one non-rectilinear channel 2 on the walls of which one or several separating layers are deposited (FIG. 12).

Within the framework of the invention, the manufacture of porous ceramic supports 1 for fluid filtration membranes and more particularly for tangential filtration membranes is aimed. Such porous supports are within the framework of the invention of a tubular geometry and include a rectilinear channel 2a and at least one circulation channel 2 or path for the fluid to be filtered. These circulation channels 2, 2a have an inlet and an outlet. The inlet of the circulation channels is positioned at one of the ends of the porous support, this end playing the role of an entry area for the fluid medium to be treated and their outlet is positioned at another end of the porous support playing the role of exit area for the retentate. The entry area and the exit area are connected by a continuous peripheral area at which the permeate is recovered.

When the porosity (the average pore diameter) of the sintered support is adapted to the fluid medium to be treated (filtration threshold), said sintered support can be directly used in filtration and is referred to as self-membrane or homogeneous membrane.

When the porosity of the sintered support is not adapted to the fluid medium to be treated (pores of too large dimension compared to the necessary filtration threshold), the walls of the circulation channel(s) 2 are continuously covered by at least one separating layer which ensures the filtration of the fluid medium to be treated. The separating layer(s) are porous and have an average pore diameter smaller than that of the support. The separating layer can either be deposited directly on the porous support (case of a single-layer separating layer), or on an intermediate layer of smaller average pore diameter, itself deposited directly on the porous support (case of a multi-layer separating layer). Thus, part of the fluid medium to be filtered passes through the separating layer(s) and the porous support, so that this treated part of the fluid, called permeate, flows through the external peripheral surface of the porous support. The separating layers delimit the surface of the filtration membrane intended to be in contact with the fluid to be treated and in contact with which the fluid to be treated circulates.

The porosity of the ceramic porous support 1 is open, that is to say it forms a network of interconnected pores in three dimensions, which allows the fluid filtered by the separating layer(s) to pass through the porous support and to be recovered on the outskirts. The permeate is therefore recovered on the peripheral surface of the porous support.

The porous support 1 has an average pore diameter belonging to the range from 0.5 μm to 50 μm. The porosity of the porous support 1 is comprised between 10 and 60%, preferably between 20 and 50%.

By “average pore diameter”, it is meant the value d50 of a volume distribution for which 50% of the total pore volume correspond to the volume of the pores with a diameter less than this d50. The volume distribution is the curve (analytical function) representing the frequencies of the volumes of the pores as a function of their diameter. The d50 corresponds to the median separating into two equal parts the surface area located under the frequency curve obtained by mercury penetration. Particularly, it is possible to use the technique described in standard ISO 15901-1:2005 with regard to the mercury penetration measurement technique.

The porosity of the porous support, which corresponds to the total volume of

the interconnected voids (pores) present in the material considered, is a physical quantity which conditions the flow and retention capacities of said porous body. For the material to be used in filtration, the total interconnected open porosity must be at least 10% for a satisfactory filtrate flow rate through the support, and at most 60% in order to guarantee suitable mechanical resistance of the porous support.

The porosity of a porous support can be measured by determining the volume of a liquid contained in said porous body by weighing said material before and after a prolonged stay in said liquid (water or other solvent). Knowing the respective densities of the material considered and of the liquid used, the mass difference, converted into volume, is directly representative of the pore volume and therefore of the total open porosity of the porous support.

Other techniques make it possible to accurately measure the total open porosity of a porous support, among which mention may be made of:
the porosimetry by mercury intrusion (ISO 15901-1 standard mentioned above): injected under pressure, the mercury fills the pores accessible at the pressures implemented, and the volume of mercury injected then corresponds to the volume of the pores;
the small-angle scattering: this technique, which uses either neutron radiation or X-rays, provides access to physical quantities averaged over the entire sample. The measurement consists in analyzing the angular distribution of the intensity scattered by the sample;
the analysis of 2D images obtained by microscopy;
the analysis of 3D images obtained by X-ray tomography.

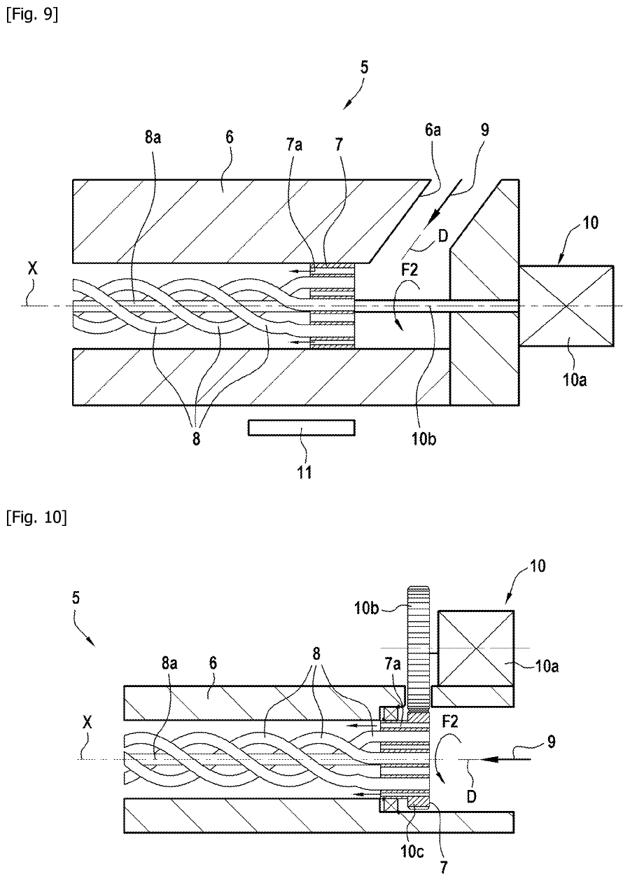

The porous tubular support 1 according to the invention is prepared by the sintering of an extrudate corresponding to the extruded object using for example a device 5 in accordance with the invention ensuring the manufacture of a porous tubular support 1 from a ceramic composition. As can be seen more specifically from FIGS. 9, 10, 11A and 11B, the device 5 in accordance with the invention includes a fixed extrusion die 6 in which is mounted a punch holder 7 provided with at least two punches 8, 8a. The fixed extrusion die 6 defines the external shape of the extrudate that exits from the extrusion die and which may be, within the framework of the invention, circular or non-circular (polygonal or the like, etc.). The fixed extrusion die 6 delimits with the punches 8, 8a, a free space or orifice through which the ceramic composition passes.

The device 5 in accordance with the invention also includes a supply device 9 to force the ceramic composition to cross under pressure the punch holder 7 in order to pass through the extrusion die 6 at a linear speed of extrusion VI. For example, the supply system 9 is a system of the piston, pump or worm-type of all types known per se, allowing the application of a mechanical pressure to the ceramic composition. The linear speed of extrusion VI is measured at the exit of the extrudate from the fixed extrusion die 6 either discontinuously by simple timing, or continuously by a remote linear speed sensor such as for example a laser velocimeter Doppler.

The porous tubular support 1 is manufactured by extrusion from a ceramic composition passing under pressure through the fixed extrusion die 6.

The ceramic composition is composed of a powdery solid inorganic phase and of a matrix.

The powdery solid inorganic phase of the ceramic composition comprises one or several solid inorganic materials, each in the form of particles with an average diameter comprised between 0.1 μm and 150 μm.

The notion of average diameter is associated with that of particle distribution. Indeed, the particles of a powder are rarely of a single or monodisperse size and a powder is therefore most often characterized by a size distribution of its particles. The average diameter then corresponds to the average of a particle size distribution. The distribution can be represented in different ways, such as a frequency or cumulative distribution. Some measurement techniques directly give a distribution based on the number (microscopy) or on the mass (sieving). The average diameter is a measurement of the central tendency.

Among the most used central tendencies, there are thus the mode, the median and the average. The mode is the most frequent diameter in a distribution: it corresponds to the maximum of the frequency curve. The median represents the value where the total frequency of the values above and below is identical (in other words, the same total number or volume of particles is found below and above the median). The average must for its part be calculated and it determines the point where the moments of the distribution are equal. For a normal distribution, the mode, the average and the median coincide, whereas they differ in the case of a non-normal distribution.

The average diameter of the particles constitutive of an inorganic powder can be measured in particular by:
laser light diffraction for particles ranging from 3 mm to approximately 0.1 μm;
sedimentation/centrifugation;
dynamic light scattering (DLS) for particles ranging from 0.5 μm to 2 nm;
analysis of images obtained by microscopy;
small-angle X-ray diffraction.

By granularity of the powdery solid inorganic phase, it is meant the dimensions of the particles composing the powdery solid inorganic phase. The granularity is characterized by the notion of average diameter which is described above.

Most often, the ceramic composition comprises, as powdery ceramic material(s), alone or as a mixture, an oxide and/or a nitride and/or a carbide. As examples of oxides which may be suitable within the framework of the invention, mention may in particular be made of metal oxides, and particularly titanium oxide, zirconium oxide, aluminum oxide and magnesium oxide, the titanium oxide being preferred. As examples of carbides, mention may in particular be made of metal carbides, and particularly silicon carbide. As examples of nitrides that can be used, mention may be made in particular of titanium nitride, aluminum nitride, and boron nitride. According to one preferred embodiment, the ceramic composition comprises at least one metal oxide as powdery inorganic material, and preferably titanium oxide.

Within the framework of the invention, the ceramic composition has a suitable rheology in terms of plasticity for its extrusion through the fixed extrusion die 6.

According to a first embodiment, the matrix of the ceramic composition comprises one or several solvents. The solvent(s) may be aqueous or organic. As examples, mention may be made of water, ethanol or acetone.

In addition, the matrix of the ceramic composition comprises one or several organic additives. Advantageously, these organic additives are soluble in the solvent(s) of the matrix. The organic additive(s) suitable within the framework of the invention can be chosen as non-limiting examples among:
binders, and for example among cellulose ethers such as hydroxyethylcellulose which is a polymer, gum arabic which is a polysaccharide, or polyethylene glycol (PEG);
lubricants and plasticizers, for example among glycerol or stearic acid;
thickeners and gelling agents, and for example among xanthan gum or agar-agar which is a polymer of galactose.

The mass content of powdery inorganic material(s) in the ceramic composition can range from 50 to 90%, preferably between 80 and 85% by weight, relative to the total weight of the ceramic composition.

The mass content of matrix in the ceramic composition can range from 10%

to 50% by weight, preferably from 15 to 20% by weight, relative to the total weight of the ceramic composition.

This ceramic composition is not a powder but a paste. It is possible to adjust the rheology of this ceramic composition thanks to the granularity of the powdery solid inorganic phase, and/or thanks to the nature of the organic additives when they are present and/or thanks to their respective proportions. Indeed, for example, the use of a matrix including one or several organic additives soluble in one or several solvents comprised in the matrix makes it possible to modify the rheology of the ceramic composition.

According to a second embodiment, the ceramic composition comprises a matrix consisting of one or several hot-melt polymers. The matrix is organic in nature and solid at room temperature.

By “hot-melt polymer” it is meant a polymer that softens under the effect of heat.

As examples of hot-melt polymer which may be suitable within the framework of the invention, mention may be made of the following optionally functionalized polymers or family of polymers, used alone or as a mixture in the matrix: polylactic acid (PLA), polyvinyl alcohol (PVA), acrylonitrile butadiene styrene (ABS), polyprolylene (PP), polyethylene, polyethylene terephthalate (PET), thermoplastic polyurethane (TPU), polyolefins, thermoplastic elastomers (TPE), polyolefin-based elastomers (TPE-O) and polycarbonate.

The mass content of powdery inorganic material(s) in the ceramic composition can range from 40 to 95%, preferably between 70 and 90% by weight, relative to the total weight of the ceramic composition.

Within the framework of the invention, the ceramic composition, preferably in the form of granules, is preheated upstream in the supply device 9 so that the hot-melt polymer(s) soften so as the ceramic composition can be pressurized upstream of the fixed extrusion head 6. Usually, the fixed extrusion head 6 is heated to soften the hot-melt polymer(s) then allowing the extrusion of the ceramic composition. The temperature of the fixed extrusion head 6 can be adjusted depending on the hot-melt polymer(s) present in the ceramic composition.

In addition, within the framework of the invention, it is possible to adjust the rheology of the ceramic composition thanks to its temperature in the fixed extrusion head, and/or the granularity of the powdery solid inorganic phase, and/or thanks to the nature of the hot-melt polymer(s) and/or thanks to their proportions.

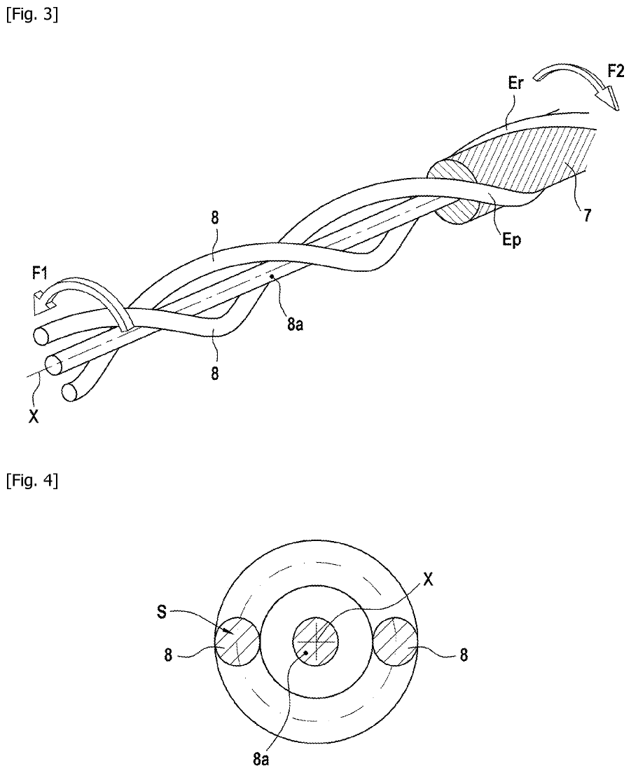

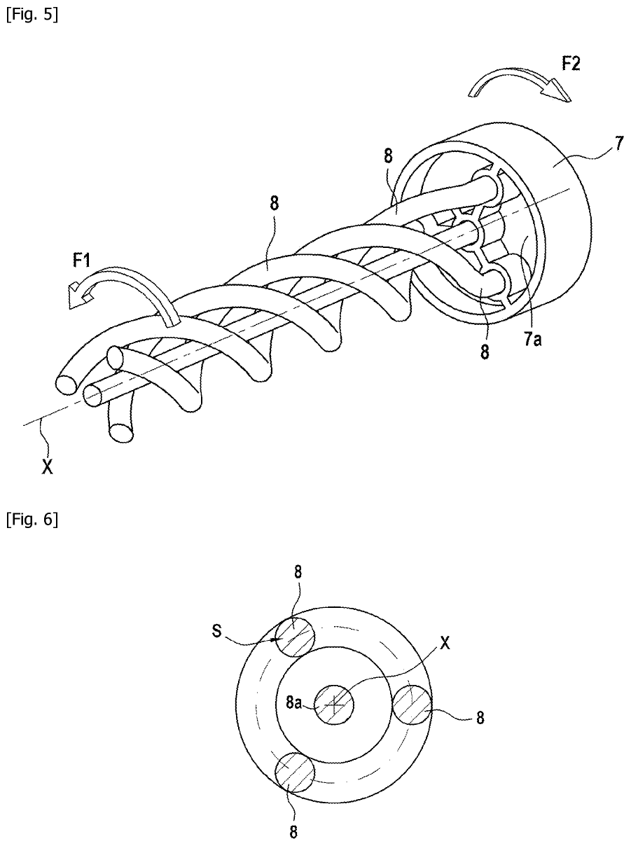

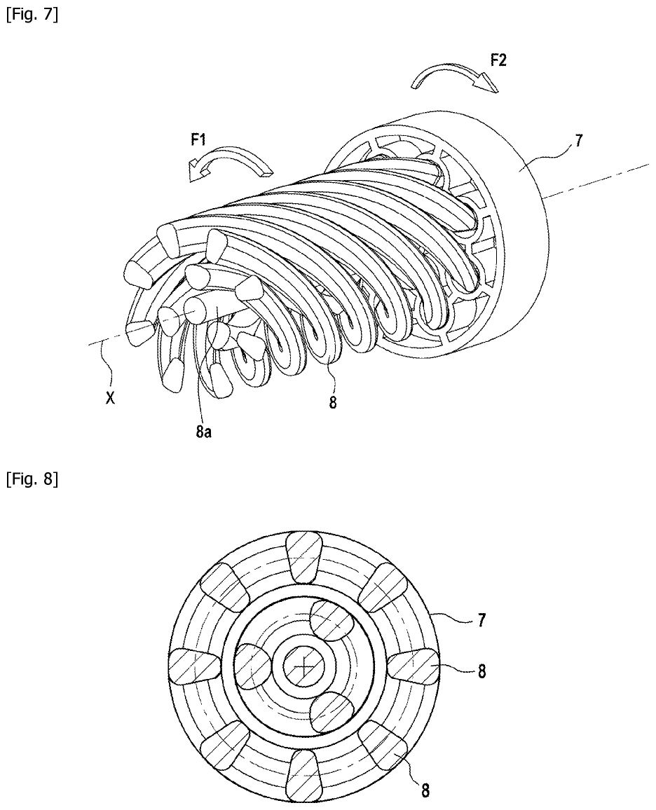

In accordance with the invention, the punch holder 7 is provided with a rectilinear punch 8a centered on the axis of symmetry X of the punch holder 7. The rectilinear punch 8a is of circular section. The punch holder 7 is also provided with at least one helically-shaped punch 8 wound around an axis of symmetry X along a winding direction F1. In the example illustrated in FIG. 2, the punch holder 7 is provided with the centered rectilinear punch 8a and with a single helically-shaped punch 8, and in accordance with the invention. Of course, the punch holder 7 can be provided, in addition to the centered rectilinear punch 8a, with a different number of helically-shaped punches 8 in accordance with the invention, for example 2 punches (FIGS. 3 and 4), 3 punches (FIGS. 5 and 6), 11 punches (FIG. 7 and 8) or 7 punches (FIG. 11B).

Generally, a helically-shaped punch 8 is a punch whose shape follows, without a central core, the shape of a circular helix. A helically-shaped punch 8 includes a body with a straight section S extending only along a circular helix H wound around the axis of symmetry X. To the extent that the helically-shaped punch 8 does not include a central core, this helical punch 8 exclusively forms circular turns wound around, along and outside the axis of symmetry X. This circular helix H corresponds to a curve inscribed on a cylinder of revolution around an axis corresponding to the axis of symmetry X, the tangent to this curve making a constant angle with the axis of symmetry. Of course, this cylinder of revolution on which the circular helix H rests corresponds to an empty space of the helical punch 8 since the latter does not include a material centered on the axis of symmetry X but exclusively has a helical body. All the points belonging to this straight section S are located at a non-zero constant distance R from the axis of symmetry X. In other words, the helical body of the punch 8 is wound around the axis of symmetry X without this axis of symmetry passing therethrough.

It should be noted that the straight section S of the helically-shaped punches 8 can have different shapes adapted to the desired shapes for the channels 2 of the porous support 1. For example, each helically-shaped punch 8 includes a round section in the examples of FIGS. 2, 3-4 and 5-6. According to the exemplary embodiment illustrated in FIGS. 7 and 8, the eight helically-shaped punches 8 belonging to the outer ring all have the same pseudo-rectangular section while the three helically-shaped punches 8 belonging to the inner ring all have the same pseudo-ovoid section. According to the exemplary embodiment illustrated in FIGS. 11A and 11B, the seven helically-shaped punches 8 belonging to the outer ring all have the same pseudo-triangular section. It should however be noted that there is no obligation for the punches of the same ring to have identical sections. It should be noted that the shape of the section of the punches 8, 8a corresponds to the shape of the channels 2 in the extrudate obtained using the device 5 in accordance with the invention.

More specifically, it is the shape of the straight section at the end of a punch that determines the shape of the straight section of the channel formed in the extrudate. The end of a punch corresponds to the section perpendicular to the axis of symmetry X which is parallel to the direction of advance of the extrudate. A final or intermediate enlargement of the punch can be advantageous with regard to the compression of the ceramic composition. In the example illustrated in FIG. 2, the centered rectilinear punch 8a and the helically-shaped punch 8 have an enlargement at their end. Of course, the sections of the centered rectilinear punch 8a and of the helically-shaped punch(es) 8 can vary in any other location. In any case, the terminal straight section of a punch is the one that in all cases gives its shape to the section of the channel.

Each helically-shaped punch 8 is wound around the axis of symmetry X along a single determined direction of winding, namely a dextrorotatory direction of winding (clockwise direction) or a levorotatory direction of winding (counterclockwise direction). In the example illustrated in FIG. 2, the helically-shaped punch 8 is wound around the axis of symmetry X along a dextrorotatory direction of winding F1. According to one characteristic of the invention, when the punch holder 7 is provided with several helically-shaped punches, all the helically-shaped punches 8 equipping a punch holder 7 are wound around the axis of symmetry X along the same direction of winding F1. Thus, all the helically-shaped punches 8 equipping a punch holder 7 have a direction of winding, for example dextrorotatory direction of winding in the examples illustrated in FIGS. 3, 5, 7 and 11B.

In addition, according to another characteristic of the invention, all the helically-shaped punches 8 equipping a punch holder 7 are wound concentrically around the same axis of symmetry X. Thus, the punch holder 7 includes an axis of symmetry X which is common to all helically-shaped punches 8.

According to one preferred characteristic of embodiment, the helically-shaped punches 8 equipping a punch holder 7 are distributed symmetrically around the axis of symmetry X, as clearly appears in FIGS. 4, 6, 8 and 11B for example. According to one variant of embodiment, the helically-shaped punches 8 are mounted on the punch holder 7 so as to be disposed in at least two concentric rings as appears in the exemplary embodiment illustrated in FIGS. 7 and 8. Thus, the punch holder 7 is provided with a first series of eight helically-shaped punches 8 disposed in an outer ring which is concentric with an inner ring along which three helically-shaped punches 8 are distributed. Advantageously, the eight helically-shaped punches 8 are evenly angularly distributed in the outer ring while the three helically-shaped punches 8 are also evenly angularly distributed on the inner ring.

Each helically-shaped punch 8 is wound around the axis of symmetry X according to a determined winding pitch P. The pitch P of a helically-shaped punch 8 corresponds to the distance taken on the helix between the two consecutive points of intersection with a straight line parallel to the axis of symmetry X. According to one characteristic of the invention, when the punch holder 7 is provided with several helically-shaped punches, all helically-shaped punches 8 equipping a punch holder 7 have the same winding pitch P.

Advantageously, the winding pitch P which, expressed in °/mm, is comprised between 1° and 90°/mm. Preferably, the winding pitch is comprised between 3.6° and 36°/mm by considering that a winding pitch of 3.6°/mm is equivalent to a winding pitch of 100 mm and that a winding pitch of 36°/mm is equivalent to a winding pitch of 10 mm. As will be better understood in the remainder of the description, the winding pitch P of the helically-shaped punch corresponds to the pitch of the channels 2 obtained in the extrudate.

It should be noted that each punch 8 has a helically-shaped part between a distal end Ed and a proximal end Ep. According to one characteristic of the invention, each punch 8 has a helically-shaped part whose length taken according to the axis of symmetry X is equal to or greater than a quarter of the winding pitch P.

Each punch 8, 8a is fixed in any appropriate manner to the punch holder 7. The punches 8, 8a thus extend protruding or overhanging along one side of the punch holder 7. Typically, the helically-shaped part of the punch 8 taken between a distal end Ed and a proximal end Ep is extended by a part of connection or fixing Er to the punch holder. For example in the example illustrated in FIG. 3, the helically-shaped punch 8 extends beyond its proximal end Ep, by a helically-shaped connecting part Er fixed on the punch holder 7 while the centered rectilinear punch 8a is fixed on the end of the holder-punches 7. In the example illustrated in FIG. 2, the helically-shaped punch 8 extends beyond its proximal end Ep, by a rectilinear-shaped connecting part Er forming part of the centered rectilinear punch 8a and fixed to the punch holder 7. In the examples illustrated in FIGS. 5 and 7, the helically-shaped punches 8 are fitted into the punch holder 7, by the connection part Er while the end of the centered rectilinear punch 8a is also fitted into the punch holder 7. In the example illustrated in FIGS. 11A, 11B, the connecting parts Er of the helically-shaped punches 8 converge towards the central part of the punch holder 7 and more specifically around the end of the centered rectilinear punch 8a. As appears from the drawings, the connecting parts Er of the helically-shaped punches 8 together form a cone converging towards the punch holder 7, making it possible to delimit around it, a collection volume 7c whose function will appear in the remainder of the description.

It should be noted that the punch holder 7 and the punches 8, 8a can be made in any appropriate manner. For example, the punch holder 7 and the punches 8, 8a can be in the form of a single piece obtained by electroerosion for example. According to another manufacturing mode, the punches 8, 8a can be separately manufactured then fixed for example by crimping on the punch holder 7 or in housings arranged in the punch holder 7. Conventionally, the punch holder 7 is designed or arranged to present one or several passages 7a allowing the ceramic composition to pass through the punch holder. It should be noted that the punch holder 7 illustrated in FIGS. 11A, 11B is not perforated but solid to the extent that the connecting parts Er of the punches and the punches between them delimit spaces for the passage of the ceramic composition arriving laterally on the outskirts.

In accordance with the invention, the device 5 includes a system 10 for driving in rotation the punch holder 7. The rotational drive system 10 can be made in any appropriate manner to ensure the rotation of the punch holder around the axis of symmetry X according to a determined speed of rotation and according to a determined direction of rotation. For example, this rotational drive system 10 can include a motor, for example electric motor, connected directly or by a transmission to the punch holder 7 and whose operation is piloted by a control device. Advantageously, the speed of rotation of the motor is adjustable so as to be able to adjust the speed of rotation of the punch holder 7.

According to one characteristic of the invention, the drive system 10 drives in rotation the punch holder 7 around the axis of symmetry X, along a direction of rotation F2 opposite to the direction of winding F1 of the punch(es) 8. Thus, as appears more specifically in FIGS. 9, 10 and 11A, the punch holder 7 is driven in rotation in the levorotatory direction F2 since the helically-shaped punches 8 equipping the punch holder 7 have a dextrorotatory direction of winding F1. Of course, it can be provided that the drive system 10 drives in rotation the punch holder 7 along a dextrorotatory direction of rotation if the helically-shaped punches 8 equipping the punch holder 7 have a levorotatory direction of winding.

According to one characteristic of the invention, the drive system 10 drives in rotation the punch holder 7 at a speed of rotation synchronized with the linear speed of extrusion VI of the ceramic composition. It should be understood that the speed of rotation of the punch holder 7 is synchronized with the linear speed of extrusion VI of the ceramic composition so that the segment of ceramic composition being extruded in the extrusion die 6 is not driven in rotation, that is to say also that this segment of ceramic composition is not subjected to torsion. This segment of ceramic composition advances strictly linearly in the extrusion die 6 thanks to the fact that each helically-shaped punch 8 while rotating gradually withdraws (is “unscrewed”) from the segment of ceramic material inside which it is located and which concomitantly advances linearly in the die.

According to one characteristic of the invention, the drive system 10 for driving in rotation the punch holder 7 with a speed of rotation Vr equal to the linear speed of extrusion VI of the ceramic composition, divided by the winding pitch P of the helically-shaped punches 8. Let the relation Vr=VI/P, with Vr expressed for example in revolutions per minute, VI expressed for example in centimeters per minute and P expressed for example in centimeters. According to the invention, it is considered that the winding pitch P of the helical punches is predefined and that the equality Vr=VI/P can be obtained by varying either only the speed of rotation of the punch holder 7 or only the linear speed of extrusion or the speed of rotation of the punch holder 7 and the linear speed of extrusion.

It should be noted that the equality relation above is considered to be met by taking into account a margin of tolerance of plus or minus 15%. Thus, the quantity VI/P (in revolution per minute) is equal to the quantity Vr (in revolution per minute) if the deviation between its two quantities varies by plus or minus 15%. In this range of tolerance, even if the segment of ceramic composition does not advance strictly linearly in the fixed extrusion die 6, the helical punches 8 ensure the extrusion of this segment of ceramic composition with an acceptable shape in the extrudate. Typically, for a pitch P equal to 10 cm and for a linear speed of extrusion VI equal to 200 cm/min then the speed of rotation Vr of the punch holder 7 must be comprised between 17 and 23 revolutions per min.

FIG. 9 illustrates a first exemplary embodiment of the device 5 in accordance with the invention in which the system 10 for driving in rotation the punch holder 7 is located at the rear of the punch holder 7. According to this illustrated exemplary embodiment, the rotational drive system 10 includes a motor 10a driving in rotation a connecting shaft 10b fixed to the punch holder 7 while being centered on the axis of symmetry X, on the face opposite to the one from which the punches extend in protrusion. Given the mounting of the rotational drive system 10 at the rear and in the axis of the punch holder 7, the axis of symmetry X of the punch holder 7 makes an angle less than or equal to 90° relative to the supply direction of the supply system 9. The supply system 9 is thus located on the side of the punch holder 7 with an inlet 6a arranged laterally in the fixed extrusion die 6 along a direction D making with respect to the axis of symmetry, an angle less than or equal to 90°, for example around 45°. The supply system 9 opens out through its inlet 6a, upstream of the punch holder 7 along the direction of progression of the ceramic composition. The passages 7a arranged in the punch holder 7 allow the ceramic composition to pass through the punch holder.

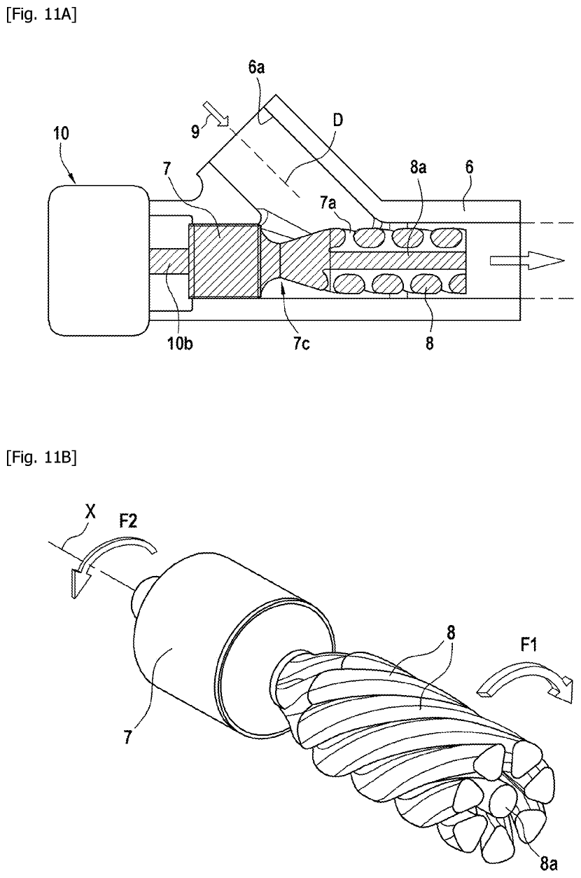

FIG. 10 illustrates an exemplary second embodiment of the device 5 in accordance with the invention in which the system 10 for driving in rotation the punch holder 7 is located on the side of the punch holder 7. The system 10 for driving in rotation the punch holder is thus mounted downstream of the supply system 9 relative to the direction of movement of the ceramic composition. According to this example, the axis of symmetry X of the punch holder is parallel to the supply direction D of the supply system 9. The supply system 9 can thus be located at the rear of the punch holder 7 so that the passages 7a provided in the punch holder 7 allow the ceramic composition to pass through the punch holder. According to the illustrated exemplary embodiment, the rotational drive system 10 includes a motor 10a laterally driving in rotation the punch holders 7, using a transmission including a pinion 10b locked in rotation with the motor output shaft and meshing with a toothed ring 10c arranged on the outskirts of the punch holder 7.

FIG. 11A illustrates a third exemplary embodiment of the device 5 in accordance with the invention in which the supply system 9 is located on the side of the punch holder 7 with an inlet 6a arranged laterally in the fixed extrusion die 6 along a direction D making, with respect to the axis of symmetry, an angle less than or equal to 90°, for example around 45°. The inlet 6a of the supply system 9 is arranged to open out laterally at the punches 8, 8a and more specifically at the level of the collection volume 7c surrounding the connecting parts Er of the helically-shaped punches 8. It should be noted that the punches 8, 8a leave spaces between them, allowing the passage of the ceramic composition so that it completely fills the extrusion die 6. The supply system 9 opens out through its inlet 6a, downstream of the punch holder 7 along the direction of progression of the ceramic composition. According to this illustrated exemplary embodiment, the rotational drive system 10 includes a motor deriving in rotation a connecting shaft 10b fixed to the punch holder 7 by being centered on the axis of symmetry X on the face opposite to that from which the punches protrude.

It should be noted that the device 5 in accordance with the invention can include a heating system 11 of the extrusion die 6 to maintain the punch holder 7, the punch(s) 8, 8a and the ceramic composition at a determined temperature, comprised between 50° C. and 300° C. The heating system 11 can be made by any system adapted to maintain the extrusion die 6, the punch holder 7, the punch(es) 8, 8a and the ceramic composition at a uniform temperature. This heating system 11 is implemented in particular when the fixed extrusion die 6 is supplied with a ceramic composition including a first powdery solid inorganic phase in the form of particles with an average diameter comprised between 0.1 and 150 micrometers and a second phase in the form of a matrix comprising at least one hot-melt polymer.

The implementation of the device 5 in accordance with the invention for

manufacturing by extrusion, a porous tubular support 2 stems directly from the preceding description.

It is first of all necessary to provide an extrusion device 5 including a fixed extrusion die 6 in which is mounted a punch holder 7 provided with a rectilinear punch 8a centered on the axis of symmetry X and with at least one helically-shaped punch 8 wound around an axis of symmetry X along a winding direction and a winding pitch P. For the manufacture of a porous tubular support from a ceramic composition, the method consists in:
ensuring that the ceramic composition crosses the punch holder 7 to pass through the extrusion die 6 at a linear speed of extrusion;
and ensuring the rotational drive of the punch holder 7 along a direction of rotation opposite to the direction of winding of the helically-shaped punch 8 and with a speed of rotation synchronized with the linear speed of extrusion of the ceramic composition.

Advantageously, the punch holder 7 is driven in rotation with a speed of rotation equal to the linear speed of extrusion of the ceramic composition, divided by the winding pitch P of the helically-shaped punch(es) 8.

For the speed of rotation of the punch holder 7 to be equal to the linear speed of extrusion of the ceramic composition, divided by the winding pitch P, the method consists in acting on the adjustment either of only the speed of rotation of the punch holder 7 or only the linear speed of extrusion adjusted by the flow rate of the supply device 9 or the speed of rotation of the punch holder 7 and the linear speed of extrusion adjusted by the flow rate of the supply device 9.

It is recalled that the fixed extrusion die 6 is supplied, using the supply device 9, with a ceramic composition of all types. Preferably, the ceramic composition includes a powdery solid inorganic phase in the form of particles with an average diameter comprised between 0.1 and 150 micrometers and a matrix. According to another example, the fixed extrusion die 6 is supplied, using the supply device, 9, with a ceramic composition including a first powdery solid inorganic phase in the form of particles with an average diameter comprised between 0.1 and 150 micrometers and a second phase in the form of a matrix comprising at least one hot-melt polymer. Of course, the supply device 9 is adapted to ensure that the ceramic composition fed to the fixed extrusion die 6 has all the characteristics, in particular pressure and malleability characteristics, to obtain effective extrusion.

At the outlet of the fixed extrusion die 6, the extrudate is recovered to be conventionally cut gradually, at a determined length to form porous tubular supports 1. Each extrudate corresponding to a length of a porous tubular support is conventionally subjected to a sintering post-treatment of all types known per se. After this sintering post-treatment of the extrudate, a porous tubular support 1 is obtained including a rectilinear channel 2a centered on the axis of symmetry of the support and at least one circulation channel 2 for a fluid medium to be treated with a helical shape derived from the imprint of a helically-shaped punch 8. Conventionally, it is known that the sintering post-treatment leads in particular to a dimensional shrinkage of the porous tubular support relative to the corresponding extrudate. This sintering shrinkage can be comprised between 5 and 25% and more specifically between 12 and 15%. As the helical shape of the channels 2 obtained in the extrudate corresponds to the negative form of the helical punches 8, the definition of the characteristics of the helical punches takes into account this sintering shrinkage in order to obtain after sintering, in the porous tubular support, channels 2 having the desired final dimensional characteristics. After sintering, the hydraulic diameter and the pitch of the channels 2 are reduced. Thus, in particular the winding pitch P, the shapes and the dimensions of the straight sections of the helical punches 8 take into account this sintering shrinkage. It is the same for the rectilinear channel 2a centered on the axis of symmetry of the support.

Such a manufacturing method makes it possible to obtain, by extrusion, a porous tubular support in the form of a monolithic ceramic porous body in which are arranged a centered rectilinear channel 2a corresponding to the imprint of the rectilinear punch 8a and at least a circulation channel 2 for a fluid medium to be treated with a helical shape corresponding to the imprint of a helically-shaped punch 8. The pressurization of the material to be extruded upstream of the die compresses in the die the powder grains of the powdery solid inorganic phase against the surfaces of the punches 8, 8a. The pressurization of the material to be extruded does not only serve to generate the linear speed VL but it also serves within the framework of the invention to compress the material against the surfaces of the punches 8, 8a. This results in an effect of wall smoothing of the material which persists after sintering at the level of the walls of the channels. The channels 2, 2a therefore have a limited wall roughness, lower than the granularity of the powdery solid inorganic phase used in the extruded ceramic composition. The walls of the channels 2, 2a have a wall roughness with bumps to the touch lower than the granularity of the powdery solid inorganic phase used in the extruded ceramic composition.

The measurement of the wall roughness of the walls of the channels 2, 2a can be carried out in all known appropriate ways. For example, a roughness meter can be used whose probe is moved on one or several generators of the channel. The arithmetical mean deviation, denoted Ra, which indicates the average roughness of the monitored surface, directly characterizes the condition of the surface in general. The measurement result, obtained according to the ISO 21920 standard, is expressed in microns. It is compared to the granularity of the powdery solid inorganic phase of the ceramic composition characterized by the average diameter of the particles of the powdery solid inorganic phase used in the extruded ceramic composition.

The wall of the circulation channel(s) 2, 2a for the fluid medium to be treated of the porous tubular support can be coated with at least one separating layer so as to constitute a tangential filtration membrane. Typically, such a tubular support 1 after having undergone a conventional sintering operation constitutes a rigid element able to support an inner pressure of at least 10 bars without bursting and preferably at least 30 bars without bursting and advantageously at least 50 bars without bursting. A bursting pressure corresponds, according to the invention, to the pressure at which a support whose porosity has previously been obstructed (with a hot-melt material such as paraffin for example) bursts under the effect of an inner overpressure relative to the pressure external to the support; this overpressure being applied in the channels with water, the pressure external to the support being the atmospheric pressure.

It appears from the preceding description that the device 5 in accordance with the invention makes it possible to easily manufacture, by extrusion, a porous tubular support 1 with helically-shaped channels 2 able to generate turbulence in order to increase the filtrate stream by reducing the clogging phenomenon. The manufacture by extrusion of the tubular supports makes it possible to obtain a production rate much higher than that of additive methods. The linear speed of extrusion, which is measured on minute timescale, is indeed generally equal to or greater than one meter per minute while the vertical printing speed of the additive methods is generally around ten hours per meter at best. It should be noted that the vertical printing speed of the additive methods is strongly dependent on the number of channels. It decreases when the number of channels increases and a multichannel support will thus be printed according to said number of channels, two to ten times slower than a single-channel support while the linear speed of extrusion remains independent of the number of channels.

Furthermore, during the extrusion in the die, the ceramic composition is not driven in rotation or is not subjected to torsion that would otherwise alter the mechanical properties of the extrudate.

The helical shape of the channels 2 obtained in the extrudate corresponds to the negative form of the helical punches 8. The number, the winding pitch P, the disposition and the shapes and dimensions of the sections of the helical punches 8 offer freedom in the definition of the channels 2 arranged in the porous tubular support.

It should be noted that the winding pitch obtained in the extrudate is predefined by the helically-shaped punch 8 and that it is the speed of rotation Vr of the punch holder 7 and the linear speed VI of the ceramic composition in the die that must be jointly adapted to this predefined winding pitch. The helically-shaped punch 8 defines in the extrudate not only the section of the channel 2 of which it is the negative but also the pitch of the channel. Thus, the winding pitch P of the helically-shaped punch 8 determines the effectiveness of the unclogging.

Each channel 2 thus presents a flexuous circulation volume between the ends of the porous tubular support. This flexuous circulation volume of course corresponds to an area of the porous support 1 not including a porous material, and limited by the walls of the channel. It should be noted that the porous tubular support 1 has, along a straight section perpendicular to its longitudinal axis, between its external surface and the wall of the channel 2, a variable thickness.

1. A porous tubular support (1) for a tangential filtration membrane, in the form of a sintered monolithic ceramic porous body, manufactured by extrusion of a ceramic composition including a powdery solid inorganic phase and in which are arranged by extrusion using punches, a rectilinear channel (2a) centered on an axis of symmetry of the support and at least one circulation channel (2) for a fluid medium to be treated with a helical shape wound around the axis of symmetry, the channels having a limited wall roughness and lower than the granularity of the powdery solid inorganic phase of the ceramic composition.

2. The porous tubular support according to claim 1 according to which the sintered monolithic ceramic porous body supports an inner pressure of at least 10 bars without bursting.

3. A tangential filtration membrane according to which at least one separating layer coats the wall of the circulation channels (2, 2a) for the fluid medium to be treated of the porous tubular support (1) according to claim 1.

4. A device for the manufacture by extrusion of a porous tubular support (2) from a ceramic composition, the device including:
a fixed extrusion die (6) in which a punch holder (7) provided with at least one punch (8) is mounted;
a system (10) for driving in rotation the punch holder (7):
and a supply device (9) to force the ceramic composition to cross under pressure the punch holder (7) in order to pass through the extrusion die (6) at a linear speed of extrusion (VI), the device being characterized in that:
the punch holder (7) is provided with a rectilinear punch (8a) centered on the axis of symmetry (X) and with at least one helically-shaped punch (8) wound around an axis of symmetry (X) along a winding direction and a winding pitch (P):
the drive system (10) driving in rotation the punch holder (7) around said axis of symmetry (X) along a direction of rotation opposite to the direction of winding of the helically-shaped punch(es) (8) and at a speed of rotation (Vr) equal to the linear speed of extrusion (VI) of the ceramic composition, divided by the winding pitch (P) of the helically-shaped punches (8).

5. The device according to claim 4, according to which the punch holder (7) is provided with several helically-shaped punches (8) concentrically wound around a common axis of symmetry (X) along the same winding direction and the same winding pitch (P).

6. The device according to the preceding claim, according to which the punch holder (7) is provided with several helically-shaped punches (8) disposed in at least two concentric rings.

7. The device according to claim 4, according to which each helically-shaped punch (8) has a length taken along the axis of symmetry (X), equal to or greater than a quarter of the winding pitch (P).

8. The device according to claim 4, according to which the drive system (10) drives in rotation the punch holder (7) with a speed of rotation (Vr) equal to the linear speed of extrusion (VI) of the ceramic composition, divided by the winding pitch (P) of the punches (8), by taking into account a tolerance margin of plus or minus 15%.

9. The device according to claim 4, according to which the supply system (9) is a piston or worm-type system.

10. The device according to claim 4, according to which it includes a system (11) for heating the extrusion die to maintain the punch holder, the punch(es) and the ceramic composition at a temperature comprised between 50° C. and 300° C.

11. The device according to claim 4, according to which the system (10) for driving in rotation the punch holder (7) is mounted downstream of the supply system (9).

12. The device according to claim 4, according to which the system (10) for driving in rotation the punch holder (7) is located on the side of the punch holder (7) so that the axis of symmetry (X) of the punch holder is parallel to the supply direction (D) of the supply system (9).

13. The device according to claim 4, according to which the system (10) for driving in rotation the punch holder (7) is located at the rear of the punch holder so that the axis of symmetry (X) of the punch holder makes an angle less than or equal to 90° relative to the supply direction (D) of the supply system (9) opening out upstream or downstream of the punch holder (7).

14. A method for manufacturing a porous tubular support (1) from a ceramic composition, including the following operations:
providing a fixed extrusion die (6) in which is mounted a punch holder (7) provided with a rectilinear punch (8a) centered on an axis of symmetry (X) and with at least one helically-shaped punch (8) wound around the axis of symmetry (X) along a winding direction and a winding pitch (P):
ensuring that the ceramic composition crosses the punch holder (7) in order to pass through the extrusion die (6) at a linear speed of extrusion (VI):
and ensuring that the punch holder (7) is driven in rotation along a direction of rotation opposite to the direction of winding of the helically-shaped punch (8) and with a speed of rotation (Vr) equal to the linear speed of extrusion (VI) of the ceramic composition, divided by the winding pitch (P) of the helically-shaped punches (8).

15. The method according to claim 14, according to which, for the speed of rotation (Vr) of the punch holder (7) to be equal to the linear speed of extrusion (VI) of the ceramic composition, divided by the winding pitch P, we act on the adjustment either of only the speed of rotation of the punch holder (7) or only the linear speed of extrusion (VI) or the speed of rotation of the punch holder and the linear speed of extrusion.

16. The method according to claim 14, according to which the fixed extrusion die (6) is supplied with a ceramic composition including a powdery solid inorganic phase in the form of particles with an average diameter comprised between 0.1 and 150 micrometers and a matrix.

17. The method according to claim 14, according to which the fixed extrusion die (6) is supplied with a ceramic composition including a first powdery solid inorganic phase in the form of particles with an average diameter comprised between 0.1 and 150 micrometers and a second phase in the form of a matrix comprising at least one hot-melt polymer.

18. The method according to claim 14, according to which at least one extrudate is recovered at the outlet of the fixed extrusion die (6) with a determined length to form a porous monolithic tubular support and in that this extrudate is subjected to a sintering post-treatment.
